(19) United States
(12) Patent Application Publication
(10) Pub. No.: US 2026/0341819 A1
(43) Pub. Date: Oct. 29, 2026

(54) BATTERY MODULE, BATTERY APPARATUS AND METHOD FOR INSPECTING LITHIUM PLATING

(71) Applicant: SK On Co., Ltd., Seoul (KR)

(72) Inventor: Soo Bin LEE, Daejeon (KR)

(21) Appl. No.: 19/638,079

(22) Filed: Apr. 2, 2026

(30) Foreign Application Priority Data
Apr. 24, 2025 (KR) 10-2025-0053830

(51) Int. Cl. H01M 10/48; G01L 9/04; H01M 10/42; H01M 50/209

(52) U.S. Cl. CPC H01M 10/482; G01L 9/04; H01M 10/425; H01M 50/209; H01M 2010/4271

(57) ABSTRACT

A battery module is disclosed. In some implementations, the battery module includes: a cell assembly including a plurality of battery cells that include a body and at least one tab connected to the body; and a pressure sensor unit disposed on at least one of the plurality of battery cells to detect pressure generated from the cell assembly, in which the pressure sensor unit includes at least one of a plurality of pressure sensors disposed in each region adjacent to a connection portion to which the tab is connected, in a body of at least one outermost battery cell among the plurality of battery cells.

### CROSS-REFERENCE TO RELATED APPLICATION(S)

This patent document claims the priority and benefits of Korean Patent Application No. 10-2025-0053830 filed on Apr. 24, 2025, the disclosure of which is incorporated herein by reference in its entirety.

### TECHNICAL FIELD

The disclosure and implementations disclosed in this patent document generally relate to a battery module, a battery apparatus, and a method for inspecting lithium plating.

### BACKGROUND

Generally, lithium plating may form when lithium ions do not intercalate into graphite and accumulate on the surface, in environments in which high energy is required to move lithium ions, such as environments in which high current flows due to rapid charging, or low-temperature environments. As degradation progresses, lithium deposited on the anode surface may form dendrites (e.g., tree-like or needle-like protrusions), and a separator may be destroyed, causing short circuits and fires. Therefore, detecting the timing of plating in the battery module is an important challenge.

Among existing inspection apparatuses for detecting lithium plating, the existing surface pressure sensor method applied to a battery module is a method of detecting surface pressure across the entire body of the battery module.

However, the existing overall surface pressure sensing method described above requires conductive leads and pressure-sensitive material to be disposed over a relatively large area in order to measure the entire surface pressure, because initial lithium plating occurs near the tabs of the cell assembly. Therefore, the existing overall surface pressure sensing method has the disadvantages of high manufacturing costs and low efficiency when taking into account both these costs and the accuracy of identifying the point of degradation.

Furthermore, the existing overall surface pressure sensing method requires numerous computational factors corresponding to the total surface pressure in order for the battery management system (BMS) to detect degradation of the battery module. Therefore, the existing overall surface pressure sensing method is not suitable for environments in which rapid detection, such as real-time detection, is required.

### SUMMARY

The present disclosure can be implemented in some embodiments to provide a battery module capable of quickly detecting pressure caused by lithium plating using a pressure sensor disposed near a tab, an initial occurrence location of lithium plating in the battery module.

Furthermore, the present disclosure can be implemented in some embodiments to provide a battery apparatus and a method for inspecting lithium plating, which detect pressure through a pressure sensor unit disposed near a tab, which is an initial occurrence location of lithium plating in a battery module, and inspect the lithium plating based on the detected pressure.

The battery module of the present disclosure may be widely applied to transportation vehicles such as electric vehicles and drones, battery charging stations, and devices within other green technology fields such as solar and wind power generation utilizing batteries. Furthermore, the battery module of the present disclosure may be used in eco-friendly electric vehicles, hybrid vehicles, and other vehicles that aim to ameliorate the effects of climate change by suppressing air pollution and greenhouse gas emissions.

Objects of the present disclosure are not limited to the above-mentioned objects. That is, other objects that are not described may be obviously understood by those skilled in the art to which the present disclosure pertains from the following description.

In some embodiments of the present disclosure, a battery module includes: a cell assembly including a plurality of battery cells that include a body and at least one tab connected to the body; and a pressure sensor unit disposed on at least one of the plurality of battery cells to detect pressure generated from the cell assembly, in which the pressure sensor unit includes at least one of a plurality of pressure sensors disposed in each region adjacent to a connection portion to which the tab is connected, in a body of at least one outermost battery cell among the plurality of battery cells.

The pressure sensor unit may include at least one of: a first pressure sensor and a second pressure sensor disposed in each region adjacent to the connection portion to which the tab is connected, in the body of one outermost battery cell among the plurality of battery cells; and a third pressure sensor and a fourth pressure sensor disposed in each region adjacent to the connection portion to which the tab is connected, in the body of the other outermost battery cell among the plurality of battery cells.

The pressure sensor unit may include at least one of: a first pressure sensor unit configured to be disposed between the one outermost battery cell among the plurality of battery cells and a case housing of the cell assembly; and a second pressure sensor unit configured to be disposed between the other outermost battery cell among the plurality of battery cells and the case housing of the cell assembly.

The at least one tab comprises a first tab and a second tab, the pressure sensor unit may include: a first substrate including a first pressure sensing line connected to a first lead and disposed in a first region adjacent to a first tab in a first direction and a second pressure sensing line connected to a second lead and disposed in a second region adjacent to a second tab in the first direction; a second substrate stacked on the first substrate, and including a first spacer comprising an open area disposed in a region corresponding to the first region and a second spacer comprising an open area disposed in a region corresponding to the second region; and a third substrate stacked on the second substrate, and including a third pressure sensing line connected to a third lead and disposed in a third region corresponding to the first region in a second direction intersecting the first direction and a fourth pressure sensing line connected to a fourth lead and disposed in a fourth region corresponding to the second region in the second direction.

The pressure sensor unit including the first substrate, the second substrate, and the third substrate may be disposed to cover the entire body of the corresponding battery cell disposed in the cell assembly.

The pressure sensor unit may include: a first pressure sensor including the first pressure sensing line, the first spacer, and the third pressure sensing line; and a second pressure sensor including the second pressure sensing line, the second spacer, and the fourth pressure sensing line, the first pressure sensing line may be disposed to face the third pressure sensing line while being physically spaced apart from the third pressure sensing line via the first spacer, and the second pressure sensing line may be disposed to face the fourth pressure sensing line while being physically spaced apart from the fourth pressure sensing line via the second spacer.

A distance between the first pressure sensing line of the first pressure sensor and the third pressure sensing line may vary through the first spacer depending on a level of pressure due to lithium plating occurring in a region near the first tab, and a distance between the second pressure sensing line of the second pressure sensor and the fourth pressure sensing line may vary through the second spacer depending on a level of pressure due to lithium plating occurring in a region near the second tab.

The battery module may further include: a protective pad disposed between the case housing of the cell assembly and the pressure sensor unit.

In some embodiments of the present disclosure, a battery apparatus may include: a cell assembly including a plurality of battery cells that include a body and at least one tab connected to the body; a pressure sensor unit disposed on at least one of the plurality of battery cells to detect pressure generated from the cell assembly; and a control unit determining whether lithium plating occurs based on the pressure sensed by the pressure sensor unit, in which the pressure sensor unit includes at least one of a plurality of pressure sensors disposed in each region adjacent to a connection portion to which the tab is connected, in a body of at least one outermost battery cell among the plurality of battery cells.

The pressure sensor unit may include at least one of: a first pressure sensor and a second pressure sensor disposed in each region adjacent to the connection portion to which the tab is connected, in the body of one outermost battery cell among the plurality of battery cells; and a third pressure sensor and a fourth pressure sensor disposed in each region adjacent to the connection portion to which the tab is connected, in the body of the other outermost battery cell among the plurality of battery cells.

The pressure sensor unit may include at least one of: a first pressure sensor unit configured to be disposed between the one outermost battery cell among the plurality of battery cells and a case housing of the cell assembly; and a second pressure sensor unit configured to be disposed between the other outermost battery cell among the plurality of battery cells and the case housing of the cell assembly.

The pressure sensor unit may include: a first substrate including a first pressure sensing line connected to a first lead and disposed in a first region adjacent to a first tab in a first direction and a second pressure sensing line connected to a second lead and disposed in a second region adjacent to a second tab in the first direction; a second substrate stacked on the first substrate, and including a first spacer comprising an open area disposed in a region corresponding to the first region and a second spacer comprising an open area disposed in a region corresponding to the second region; and a third substrate stacked on the second substrate, and including a third pressure sensing line connected to a third lead and disposed in a third region corresponding to the first region in a second direction intersecting the first direction and a fourth pressure sensing line connected to a fourth lead and disposed in a fourth region corresponding to the second region in the second direction.

The pressure sensor unit including the first substrate, the second substrate, and the third substrate may be disposed to cover the entire body of the corresponding battery cell disposed in the cell assembly.

The pressure sensor unit may include: a first pressure sensor including the first pressure sensing line, the first spacer, and the third pressure sensing line; and a second pressure sensor including the second pressure sensing line, the second spacer, and the fourth pressure sensing line, the first pressure sensing line may be disposed to face the third pressure sensing line while being physically spaced apart from the third pressure sensing line via the first spacer, and the second pressure sensing line may be disposed to face the fourth pressure sensing line while being physically spaced apart from the fourth pressure sensing line via the second spacer.

A distance between the first pressure sensing line and the third pressure sensing line may vary through the first spacer depending on a level of pressure due to lithium plating occurring in a region near the first tab, and a distance between the second pressure sensing line and the fourth pressure sensing line may vary through the second spacer depending on a level of pressure due to lithium plating occurring in a region near the second tab.

The battery apparatus may further include: a protective pad disposed between the case housing of the cell assembly and the pressure sensor unit.

The control unit may be included in a battery management system connected to the cell assembly.

The control unit may include: a voltage detection unit supplying a driving voltage to the pressure sensor unit and detecting a detection voltage output from the pressure sensor unit; and a lithium plating determination unit determining the occurrence of the lithium plating based on the detection voltage and outputting a notification signal when the lithium plating occurs.

In some embodiments of the present disclosure, a method for inspecting lithium plating performed in a battery management system connected to a pressure sensor unit disposed on at least one outermost battery cell of a cell assembly including a plurality of battery cells includes: supplying a driving voltage to the pressure sensor unit and detecting a detection voltage output from the pressure sensor unit; and calculating a sensor resistance of the pressure sensor unit based on the detection voltage; calculating a measured pressure based on the sensor resistance; comparing the measured pressure with a preset reference pressure; and determining the occurrence of the lithium plating when the measured pressure exceeds the reference pressure.

The method may further include: providing a notification signal when it is determined that the lithium plating has occurred.

Also, aspects of the present disclosure are not limited to the examples described above, and additional aspects may be understood in the course of the following description.

### BRIEF DESCRIPTION OF DRAWINGS

Certain aspects, features, and advantages of the present disclosure are illustrated by the following detailed description with reference to the accompanying drawings.

FIG. 1 is a schematic diagram of a battery module and a battery apparatus according to an embodiment of the present disclosure.

FIG. 2 is an exemplary diagram of a sensing position of a pressure sensor.

FIG. 3 is an exemplary diagram of an arrangement position of a pressure sensor.

FIG. 4 is an exemplary diagram of a detailed configuration of first and second pressure sensor units of a pressure sensor unit.

FIG. 5 is an exemplary diagram of first, second, and third substrates of the pressure sensor.

FIG. 6 is an exemplary diagram of the first and second pressure sensors of the pressure sensor.

FIG. 7 is an exemplary diagram illustrating a state of the first pressure sensor before pressure is generated.

FIG. 8 is an exemplary diagram illustrating the state of the first pressure sensor after pressure is generated.

FIG. 9 is an exemplary diagram of a protective pad of the pressure sensor.

FIG. 10 is a perspective view illustrating an example of the overall structure of a battery module.

FIG. 11 is an exemplary diagram of a control unit.

FIG. 12 is an exemplary diagram of a detailed configuration of the control unit.

FIG. 13 is a graph illustrating a detection voltage-pressure relationship.

FIG. 14 is a graph illustrating a sensor resistance-pressure relationship.

FIG. 15 is a flowchart illustrating a method of detecting lithium plating according to an embodiment of the present disclosure.

FIG. 16 is an exemplary diagram of a notification step.

FIG. 17 is a block diagram of a computing device 1000 that may fully or partially implement a battery module, a battery apparatus, and a method according to an embodiment of the present disclosure.

In the illustrated embodiment, each component may have different functions and capabilities other than those described below, and may include additional components other than those described below.

In the drawings and detailed description, like reference numerals may refer to like components. The drawings may not be to scale, and the relative sizes, proportions, and depictions of drawing elements may be enlarged or reduced for clarity, explanation, and convenience.

### DETAILED DESCRIPTION

Features of the present disclosure disclosed in this patent document are described by example embodiments with reference to the accompanying drawings.

Hereinafter, embodiments of the present disclosure will be further described with reference to specific experimental examples. Examples and comparative examples included in the experimental examples are merely illustrative of the present disclosure and do not limit the scope of the appended claims. It will be apparent to those skilled in the art that various modifications and variations of the examples are possible within the scope of the present disclosure, and such modifications and variations are also within the scope of the appended claims.

The present disclosure may be variously modified and have several exemplary embodiments. Therefore, specific exemplary embodiments of the present disclosure will be illustrated in the accompanying drawings and be described in detail. However, it is to be understood that the present disclosure is not limited to a specific exemplary embodiment, but includes all modifications, equivalents, and substitutions without departing from the scope and spirit of the present disclosure.

Terms used in the specification, ‘first,’ ‘second,’ etc. can be used to describe various components, but the components are not to be construed as being limited to the terms. The terms are used to distinguish one component from another component. For example, a ‘first’ component may be named a ‘second’ component and the ‘second’ component may also be similarly named the ‘first’ component, without departing from the scope of the present disclosure. A term ‘and/or’ includes a combination of a plurality of related described items or any one of the plurality of related described items.

Terms used in the present specification are used only in order to describe specific exemplary embodiments rather than limiting the present disclosure. Singular expressions are intended to include plural expressions unless the context clearly represents otherwise. It will be further understood that the terms “comprises” or “has” used in this specification, specify the presence of stated features, steps, operations, components, parts mentioned in this specification, or a combination thereof, but do not preclude the presence or addition of one or more other features, numerals, steps, operations, components, parts, or a combination thereof.

Unless indicated otherwise, it is to be understood that all the terms used in the specification including technical and scientific terms have the same meaning as those that are generally understood by those who are skilled in the art. Terms generally used and defined by a dictionary should be interpreted as having the same meanings as those within the context of the related art and should not be interpreted as having ideal or excessively formal meanings unless being clearly defined otherwise in the present specification.

Hereinafter, exemplary embodiments of the present disclosure will be described in more detail with reference to the accompanying drawings.

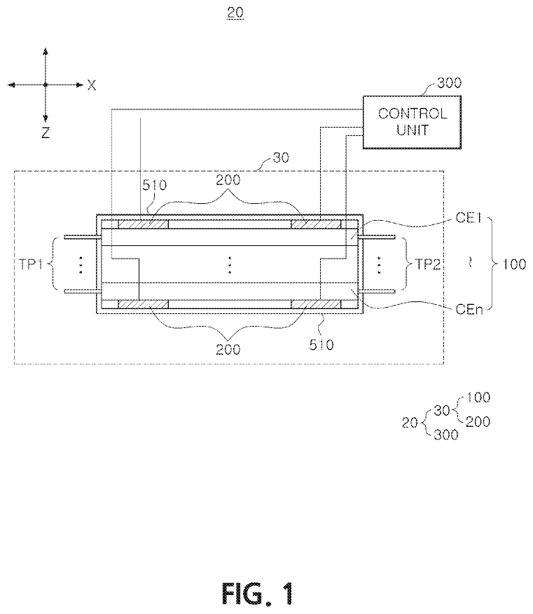

FIG. 1 is a schematic diagram of a battery module and an apparatus for inspecting lithium plating according to an embodiment of the present disclosure.

Referring to FIG. 1, a battery apparatus 20 according to an embodiment of the present disclosure may include a battery module 30 and a control unit 300.

For example, the battery module 30 may include a cell assembly 100 and a pressure sensor unit 200. For example, in the present disclosure, the battery module 30 may include the cell assembly 100 including a plurality of battery cells CE1 to CEn. Each of the plurality of battery cells CE1 to CEn may include a body and at least one tab connected to the body. The body may correspond to the remaining portion of the battery cell excluding the tab. Furthermore, the present disclosure is not limited to a specific structure or type of the battery module 30.

For example, the cell assembly 100 may include a plurality of battery cells CE1 to CEn (where n is a natural number greater than or equal to 2). For example, the plurality of battery cells CE1 to CEn of the present disclosure may be square cells, but are not limited to cells of a specific shape.

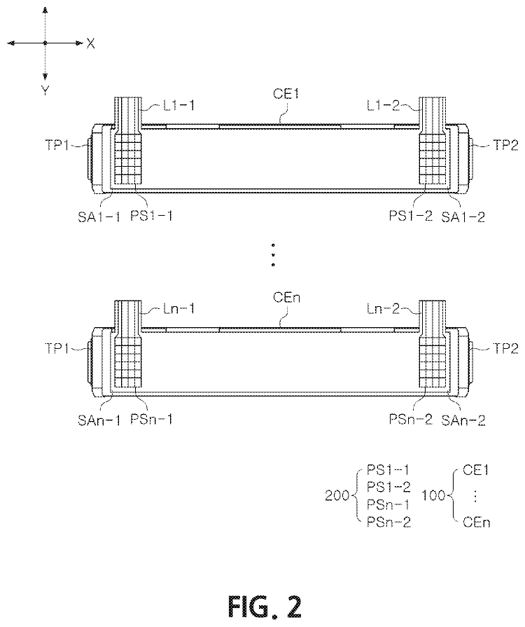

For example, the pressure sensor unit 200 may be disposed in at least one of the plurality of battery cells CE1 to CEn to detect pressure generated from the cell assembly 100. This will be described below with reference to FIG. 2.

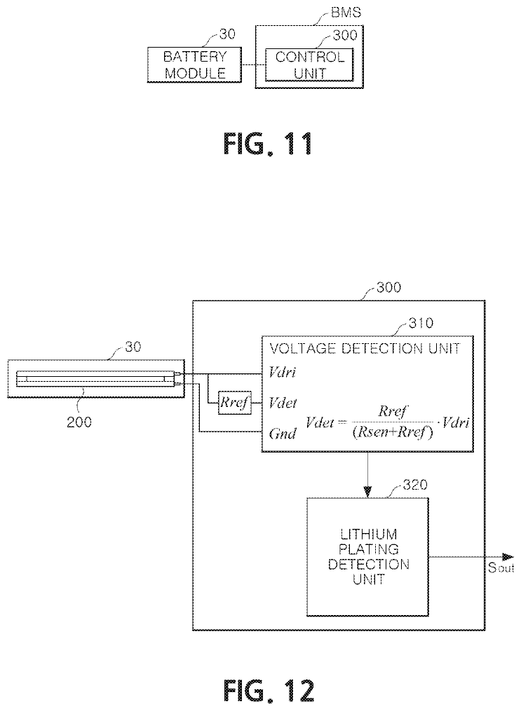

For example, the control unit 300 may determine whether lithium plating has occurred based on the pressure sensed by the pressure sensor unit 200. This will be described below with reference to FIGS. 11 and 12.

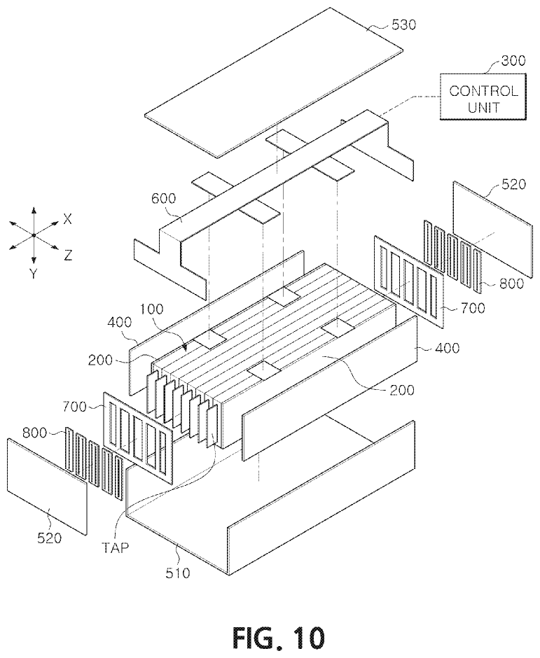

For example, in the present disclosure, the battery apparatus 20 may be a battery pack. In this case, the battery apparatus 20 may include a battery management system (BMS) connected to the pressure sensor unit 200 via a flexible circuit board 600 (see FIG. 10).

In the respective drawings in the present disclosure, an unnecessary overlapping description for components denoted by the same reference numerals and having the same functions will be omitted, and contents different from each other in the respective drawings will be described.

FIG. 2 is an exemplary diagram of a sensing position of a pressure sensor.

Referring to FIG. 2, for example, the pressure sensor unit 200 may include at least one of a plurality of pressure sensors PS1-1, PS1-2, PSn-1, and PSn-2 disposed in each region SA1-1, SA1-2, SAn-1, and SAn-2 adjacent to the connection portion to which tabs TP1 and TP2 are connected, in the body of at least one outermost battery cell CE1 or CEn among the plurality of battery cells CE1 to CEn.

In the present disclosure, the meaning of “adjacent” is “close while maintaining a predetermined distance” without physically making direct contact, which may include a general dictionary meaning. In the present disclosure, the meaning of “a predetermined distance” is not a specific distance, but may be “a distance that is not physically in contact and is electrically separated.” For example, in the present disclosure, the meaning of ‘adjacent to the tab’ or ‘adjacent to the connection portion to which the tab is connected’ means ‘close to the tab’ or ‘close to the connection portion to which the tab is connected,’ and may relatively mean that the pressure sensor of the pressure sensor unit is disposed closer to the connection portion of the tab than to a middle position of the body.

For example, the pressure sensor unit 200 may be disposed in a region close to at least one of a first tab TP1 and a second tab TP2 on both sides of the cell assembly 100. For example, when the first tab TP1 is a positive (+) tab, the second tab TP2 may be a negative (−) tab, and vice versa.

For example, the pressure sensor unit 200 may include at least one pressure sensor among first and second pressure sensors PS1-1 and PS1-2 and third and fourth pressure sensors PSn-1 and PSn-2.

For example, the first and second pressure sensors PS1-1 and PS1-2 may be disposed in respective regions adjacent to the first and second tabs on both sides of one outermost battery cell CE1 among the plurality of outermost battery cells CE1 and CEn.

For example, the third and fourth pressure sensors PSn-1 and PSn-2 may be disposed in respective regions adjacent to the first and second tabs on both sides of the other outermost battery cell CEn among the plurality of outermost battery cells CE1 and CEn.

For example, the pressure sensor unit 200 may include all of the first, second, third, and fourth pressure sensors PS1-1, PS1-2, PSn-1, and PSn-2. Alternatively, the pressure sensor unit 200 may include at least first and second pressure sensors PS1-1 and PS1-2 or at least the third and fourth pressure sensors PSn-1 and PSn-2 among the first, second, third, and fourth pressure sensors PS1-1, PS1-2, PSn-1, and PSn-2.

For example, the pressure sensor unit 200 of the present disclosure is not limited to the first, second, third, and fourth pressure sensors PS1-1, PS1-2, PSn-1, and PSn-2 illustrated in FIG. 2, and may further include pressure sensors installed between the plurality of battery cells CE1 to CEn.

Additionally, for example, the first, second, third, and fourth pressure sensors PS1-1, PS1-2, PSn-1, and PSn-2 may each be connected to the control unit 300 via corresponding conductive leads L1-1, L1-2, Ln-1, and Ln-2.

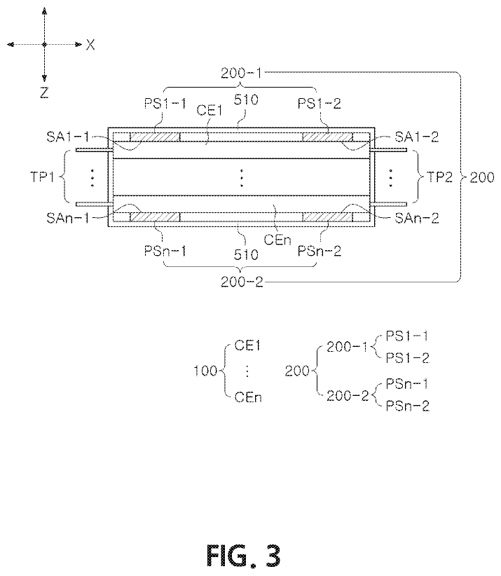

FIG. 3 is an exemplary diagram of an arrangement position of a pressure sensor.

Referring to FIG. 3, for example, the pressure sensor unit 200 may include at least one of a first pressure sensor unit 200-1 and a second pressure sensor unit 200-2.

For example, the first pressure sensor unit 200-1 may be disposed between one outermost battery cell CE1 among the plurality of battery cells CE1 to CEn and a case housing 510 of the cell assembly 100. For example, when the first pressure sensor unit 200-1 is disposed between the case housing 510 of the cell assembly 100 and the first battery cell CE1, which is the outermost battery cell, the first pressure sensor unit 200-1 may include the first pressure sensor PS1-1 and the second pressure sensor PS1-2 disposed in regions SA1-1 and SA1-2 adjacent to the connection portion to which the first tab TP1 and the second tab TP2 on both sides of the first battery cell CE1, which is the outermost battery cell, are connected.

For example, the second pressure sensor unit 200-2 may be disposed between the other outermost battery cell CEn among the plurality of battery cells CE1 to CEn and the case housing 510 of the cell assembly 100. As another example, when the second pressure sensor unit 200-2 is disposed between the case housing 510 of the cell assembly 100 and an n-th battery cell CEn, which is the outermost battery cell, the second pressure sensor unit 200-2 may include the third pressure sensor PSn-1 and the fourth pressure sensor PSn-2 disposed in regions SAn-1 and SAn-2 adjacent to the connection portion to which the first tab TP1 and the second tab TP2 on both sides of the n-th battery cell CEn, which is the outermost battery cell, are connected.

For example, the advantage of the pressure sensor unit 200 being disposed between at least one outermost battery cell CE1 or CEn and the case housing 510 of the cell assembly 100 is that the outermost battery cells CE1 and CEn among the plurality of battery cells CE1 to CEn have the lowest temperature and the highest probability of plating, and disposing the pressure sensor unit 200 between the battery assemblies is inefficient in terms of the battery manufacturing process.

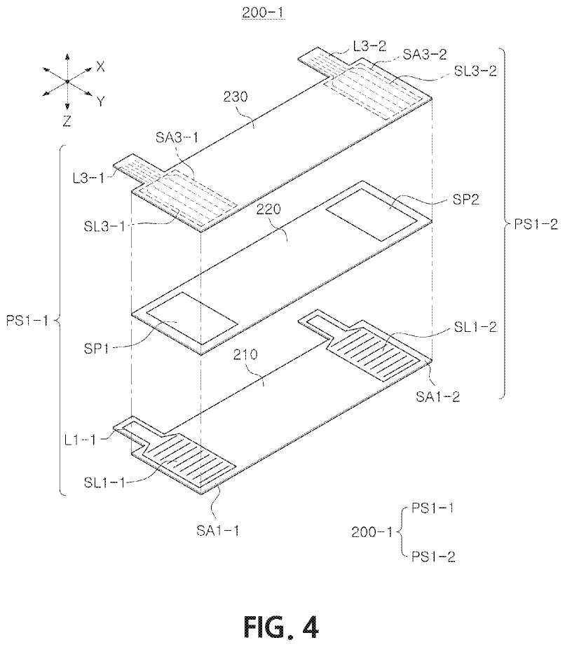

FIG. 4 is an exemplary diagram of a detailed configuration of first and second pressure sensor units of a pressure sensor unit.

Referring to FIG. 4, for example, the pressure sensor unit 200 may include at least one of the first pressure sensor unit 200-1 and the second pressure sensor unit 200-2.

For example, the first pressure sensor unit 200-1 may include a pair of first pressure sensors PS1-1 and second pressure sensors PS1-2, and the second pressure sensor unit 200-2 may include another pair of third pressure sensor PSn-1 and fourth pressure sensor PSn-2.

For example, the first pressure sensor unit 200-1 and the second pressure sensor unit 200-2 may each have the same structure. As a representative example, the structure of the first pressure sensor unit 200-1 will be further described with reference to FIG. 4.

Referring to FIG. 4, for example, the pressure sensor unit 200 may include a first substrate 210, a second substrate 220, and a third substrate 230. For example, when the pressure sensor unit 200 includes the first pressure sensor unit 200-1, the first pressure sensor unit 200-1 may include the first substrate 210, the second substrate 220, and the third substrate 230. As another example, when the pressure sensor unit 200 includes the second pressure sensor unit 200-2, the second pressure sensor unit 200-2 may include the first substrate 210, the second substrate 220, and the third substrate 230.

For example, the first substrate 210 may include a first pressure sensing line SL1-1 connected to the first lead L1-1 and disposed in the first region SA1-1 adjacent to the first tab TP1 in a first direction (e.g., X-direction), and a second pressure sensing line SL1-2 connected to the second lead L1-2 and disposed in the second region SA1-2 adjacent to the second tab TP2 in the first direction (e.g., X-direction). As an example, the first pressure sensing line SL1-1 and the second pressure sensing line SL1-2 may be first sensing circuits for sensing pressure. The first sensing circuits SL1-1 and SL1-2 may be disposed on a surface (e.g., an upper surface in FIG. 4) of the first substrate 210 facing the third substrate 230.

For example, the second substrate 220 may be stacked on the first substrate 210 and may include a first spacer SP1 which is an open region disposed in a region corresponding to the first region SA1-1, and a second spacer SP2 which is an open region disposed in a region corresponding to the second region SA1-2.

For example, the third substrate 230 may be stacked on the second substrate 220, and may include a third pressure sensing line SL3-1 that is connected to the third lead L3-1 and disposed in the third region SA3-1 corresponding to the first region SA1-1 in a second direction (e.g., Y-direction) intersecting the first direction (e.g., X-direction), and a fourth pressure sensing line SL3-2 that is connected to the fourth lead L3-2 and disposed in a fourth region SA3-2 corresponding to the second region SA1-2 in the second direction (e.g., Y-direction).

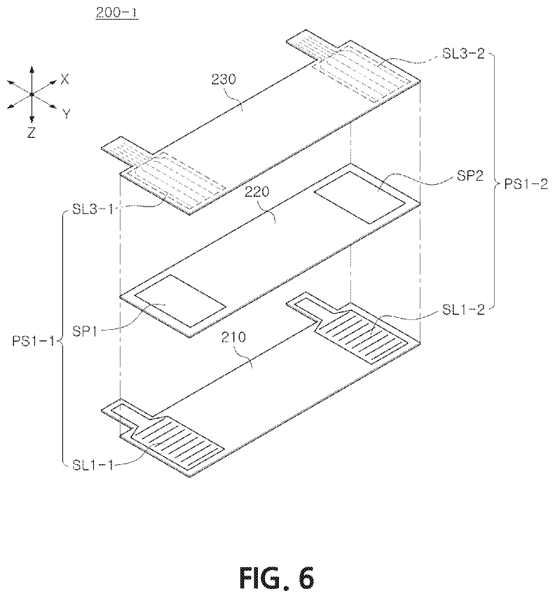

For example, the first pressure sensor PS1-1 of the first pressure sensor unit 200-1 may include the first pressure sensing line SL1-1, the first spacer SP1, and the third pressure sensing line SL3-1. The second pressure sensor PS1-2 of the first pressure sensor unit 200-1 may include the second pressure sensing line SL1-2, the second spacer SP2, and the fourth pressure sensing line SL3-2. This will be further described with reference to FIG. 6.

For example, the third pressure sensing line SL3-1 and the fourth pressure sensing line SL3-2 may be second sensing circuits for sensing pressure. The second sensing circuits SL3-1 and SL3-2 may be disposed on a surface (e.g., a lower surface in FIG. 4) of the third substrate 230 facing the first substrate 210.

For example, the first substrate 210, the second substrate 220, and the third substrate 230 may be a flexible printed circuit board (FPCB) containing polyester and polyimide.

For example, the first pressure sensing line SL1-1, the second pressure sensing line SL1-2, the third pressure sensing line SL3-1, and the fourth pressure sensing line SL3-2 may be conductive wiring, and may perform a force-sensitive resistor (FSR) function in which a resistance value changes according to the force generated by the pressure within the cell assembly.

For example, the first lead L1-1, the second lead L1-2, the third lead L3-1, and the fourth lead L3-2 are connected to the first pressure sensing line SL1-1, the second pressure sensing line SL1-2, the third pressure sensing line SL3-1, and the fourth pressure sensing line SL3-2, respectively, and may be conductive wires made of, for example, copper, iron, and nickel, or an alloy thereof, and may transmit electrical signals between the pressure sensor unit 200 and the control unit 300.

For example, the first spacer SP1 and the second spacer SP2 may be spatial gaps formed between the first sensing circuits SL1-1 and SL1-2 and the second sensing circuits SL3-1 and SL3-2.

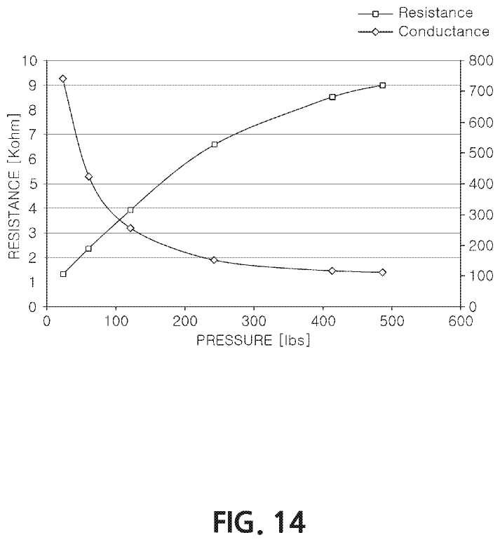

For example, before pressure is applied, the first sensing circuits SL1-1 and SL1-2 and the second sensing circuits SL3-1 and SL3-2 are physically separated from each other by a predetermined distance maintained by the first spacer SP1 and the second spacer SP2, and thus are not in physical contact with each other, such that a sensor resistance Rsen (see FIG. 14) between the first sensing circuits SL1-1 and SL1-2 and the second sensing circuits SL3-1 and SL3-2 may be relatively high.

As another example, after pressure is applied, the first sensing circuits SL1-1 and SL1-2 and the second sensing circuits SL3-1 and SL3-2 may be brought into contact with each other through the first spacer SP1 and the second spacer SP2, and thus, the sensor resistance Rsen (see FIG. 14) between the first sensing circuits SL1-1 and SL1-2 and the second sensing circuits SL3-1 and SL3-2 may be zero or very low close to zero.

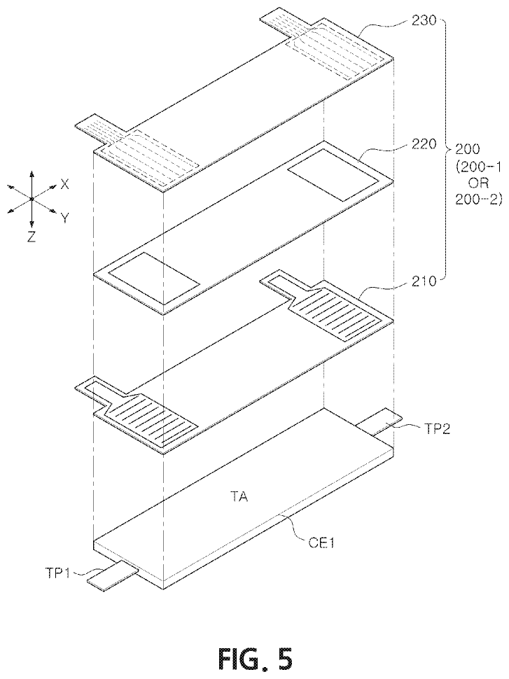

FIG. 5 is an exemplary diagram of first, second, and third substrates of the pressure sensor.

Referring to FIG. 5, for example, the first substrate 210, the second substrate 220, and the third substrate 230 of the pressure sensor unit 200 may be disposed to cover the entire body TA of a corresponding battery cell (e.g., CE1) disposed in the cell assembly 100. For example, the body TA may be an outer surface region of the battery cell corresponding to an electrode region where an internal electrode affecting the capacity of the battery is disposed.

For example, when the lithium plating occurs in the cell assembly 100, the first substrate 210, the second substrate 220, and the third substrate 230 of the pressure sensor unit 200 may minimize the surface pressure imbalance caused by the lithium plating.

FIG. 6 is an exemplary diagram of the first and second pressure sensors of the pressure sensor.

Referring to FIG. 6, for example, the first pressure sensor unit 200-1 of the pressure sensor unit 200 may include the first pressure sensor PS1-1 and the second pressure sensor PS1-2.

For example, the first pressure sensor PS1-1 may include the first pressure sensing line SL1-1, the first spacer SP1, and the third pressure sensing line SL3-1. Furthermore, the second pressure sensor PS1-2 may include the second pressure sensing line SL1-2, the second spacer SP2, and the fourth pressure sensing line SL3-2.

For example, the first pressure sensing line SL1-1 may be disposed to face the third pressure sensing line SL3-1 while being physically separated from the third pressure sensing line SL3-1 by the first spacer SP1. Accordingly, the distance between the first pressure sensing line SL1-1 and the third pressure sensing line SL3-1 may change via the first spacer SP1 depending on the level of the pressure generated within the cell assembly.

For example, the second pressure sensing line SL1-2 of the pressure sensor unit 200 may be disposed to face the fourth pressure sensing line SL3-2 while being physically spaced apart from the fourth pressure sensing line SL3-2 via the second spacer SP2. Accordingly, the distance between the second pressure sensing line SL1-2 and the fourth pressure sensing line SL3-2 may change via the second spacer SP2 depending on the level of the pressure generated within the cell assembly.

The structure of the first pressure sensor unit 200-1 is described with reference to FIG. 6, and since the structure of the second pressure sensor unit 200-2 is also the same as that of the first pressure sensor unit 200-1, a description of the specific structure is omitted.

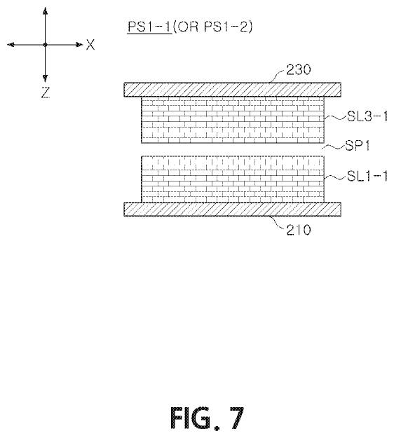

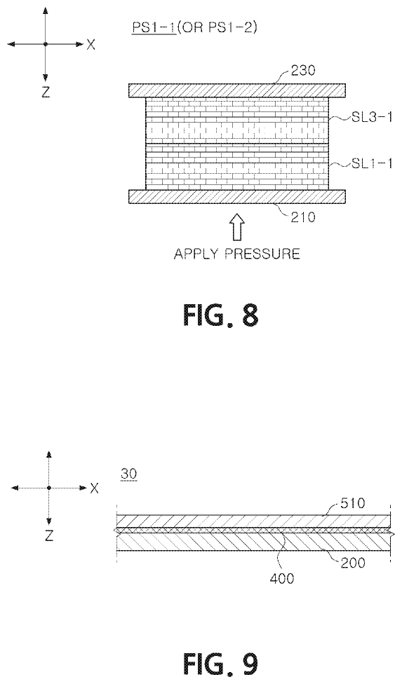

FIG. 7 is an exemplary diagram illustrating a state of the first pressure sensor before pressure is generated, and FIG. 8 is an exemplary diagram illustrating the state of the first pressure sensor after pressure is generated.

Referring to FIGS. 7 and 8, for example, the first pressure sensing line SL1-1 of the first pressure sensor PS1-1 may vary its distance from the third pressure sensing line SL3-1 via the first spacer SP1 depending on the level of the pressure due to lithium plating occurring in a region SA1-1 adjacent to the first tab TP1(see FIG. 3).

In addition, for example, the second pressure sensing line SL1-2 of the second pressure sensor PS1-2 may vary its distance from the fourth pressure sensing line SL3-2 via the second spacer SP2 depending on the level of the pressure due to lithium plating occurring in a region SA1-2 adjacent to the second tab TP2(see FIG. 3).

Referring to FIG. 7, for example, when the lithium plating does not occur in the cell assembly, the first pressure sensing line SL1-1 of the first pressure sensor PS1-1 may be spaced apart from the third pressure sensing line SL3-1 by a predetermined distance by the first spacer SP1. Accordingly, the first pressure sensing line SL1-1 may be in a non-contact state with the third pressure sensing line SL3-1 by the first spacer SP1, so the sensor resistance Rsen of the first pressure sensor PS1-1 may be a resistance value greater than a preset reference resistance.

Referring to FIG. 8, for example, when the lithium plating occurs in the cell assembly, the first pressure sensing line SL1-1 of the first pressure sensor PS1-1 may move through the first spacer SP1 due to the pressure and come into contact with the third pressure sensing line SL3-1, so the sensor resistance Rsen of the first pressure sensor PS1-1 may have a resistance value lower than a preset reference resistance.

FIG. 9 is an exemplary diagram of a protective pad of the pressure sensor.

Referring to FIG. 9, for example, the battery module 30 according to an embodiment of the present disclosure may include a protective pad 400.

For example, the protective pad 400 may be disposed between the case housing 510 of the cell assembly 100 and the pressure sensor unit 200 to protect the pressure sensor unit 200 from the case housing 510 of the cell assembly 100. For example, the protective pad 400 may be made of an insulating material.

FIG. 10 is a perspective view illustrating an example of the overall structure of a battery module.

Referring to FIG. 10, the overall structure of the battery module according to an embodiment of the present disclosure will be described. The cell assembly 100 is accommodated in the case housing 510, and the protective pad 400 (see FIG. 9) may be disposed between the outermost battery cells CE1 and CEn (FIG. 1) of the case housing 510 and the case housing 510. The pressure sensor unit 200 may be disposed between the protective pad 400 (see FIG. 9) and the outermost battery cells CE1 and CEn (FIG. 1).

For example, tabs TAP are connected to both end portions of the cell assembly 100 in the longitudinal direction (e.g., X-direction), and each individual electrode plate of the tab TAP (e.g., TP1, TP2 in FIG. 1) may be electrically connected to a bus bar 800 having a plurality of metal members that are electrically separated from each other by a bus bar frame 700, and the bus bar 800 may be connected to the tabs TP1 and TP2 through welding.

For example, each of the pressure sensor unit 200 and the bus bar 800 may be connected to the control unit 300 through individual wiring of the flexible circuit board 600.

For example, the open side of the ‘U’-shaped case housing 510 that accommodates the cell assembly 100 may be coupled with an end cover 520, and the open top of the case housing 510 may be coupled with an upper cover 530.

FIG. 11 is an exemplary diagram of the control unit.

Referring to FIG. 11, for example, the control unit 300 may be included in a battery management system (BMS) connected to the cell assembly 100. This is merely an embodiment of the present disclosure and is not limited thereto.

FIG. 12 is an exemplary diagram of a detailed configuration of the control unit.

Referring to FIG. 12, for example, the control unit 300 may include a voltage detection unit 310 and a lithium plating determination unit 320.

For example, the voltage detection unit 310 may supply a driving voltage Vdri to the pressure sensor unit 200 and detect a detection voltage Vdet output from the pressure sensor unit 200. For example, the detection voltage Vdet may be obtained as in Equation 1 below.

Vdet=[(Rref)/(Rsen+Rref)]*Vdri [Equation 1 ]

In Equation 1, Rref is a reference resistance that appears equivalent between a driving voltage Vdri output terminal and a detection voltage Vdet input terminal, and Rsen is a sensing resistance for the pressure sensor unit 200 of the battery module 30.

For example, according to the above Equation 1, when the detection voltage Vdet is detected, the value of the sensing resistance Rsen for the pressure sensor unit 200 of the battery module 30 may be obtained, and by comparing the value of the sensing resistance Rsen with a predetermined reference value, it may be determined whether the lithium plating occurs.

For example, the lithium plating determination unit 320 may determine the occurrence of lithium plating based on the detection voltage Vdet, and when it is determined that the lithium plating has occurred, may output an alarm signal Sout to notify the occurrence of the lithium plating. For example, the alarm signal may include information to notify the occurrence of the lithium plating, and the alarm signal may be used for an alarm display or transmission of an alarm signal.

For example, in the present disclosure, the control unit 300 may include at least one processor, and the voltage detection unit 310 and the lithium plating determination unit 320 may be implemented as individual processors or a single processor. In addition, the voltage detection unit 310 and the lithium plating determination unit 320 may be implemented as hardware element(s) or software element(s) or a combination thereof in at least one integrated circuit (IC) built into the battery apparatus 20, and are not particularly limited to any one thereof.

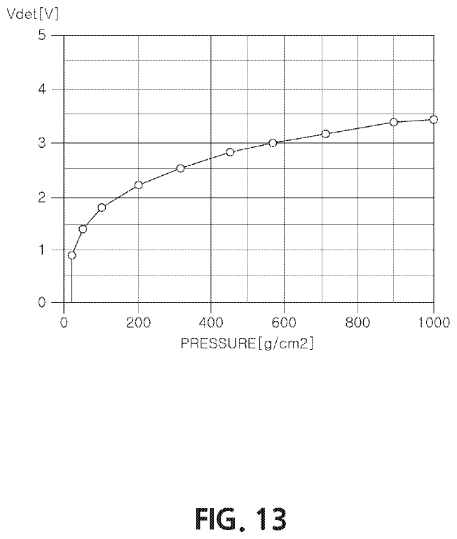

FIG. 13 is a graph illustrating a detection voltage-pressure relationship.

Referring to a graph showing a relationship between a detection voltage Vdet and pressure (g/cm²) illustrated in FIG. 13, it can be seen that the pressure (g/cm²) increases as the detection voltage Vdet increases. Referring to the graph illustrated in FIG. 13, once the detection voltage Vdet is determined, the corresponding pressure may be determined.

FIG. 14 is a graph illustrating a sensor resistance-pressure relationship.

Referring to the graph showing the relationship between the sensor resistance Rsen and pressure lbs illustrated in FIG. 14, it may be seen that the pressure lbs increases as the sensor resistance Rsen decreases.

For example, when the lithium plating occurs in the battery module, the pressure increases as the volume expands within the cell assembly, and when the pressure increases, the sensor resistance decreases. Therefore, when the sensor resistance is calculated, the corresponding measured pressure may be obtained. When this measured pressure exceeds the reference pressure, it may be determined that the lithium plating has occurred.

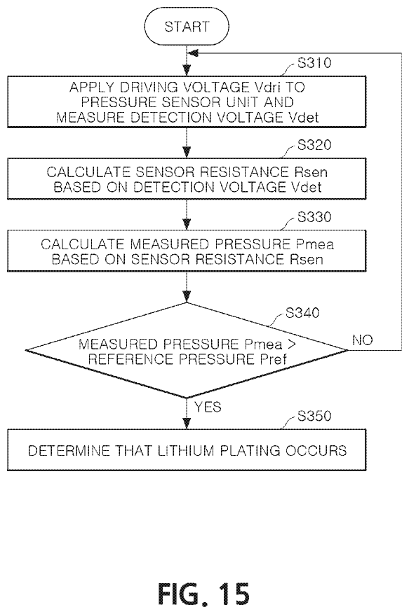

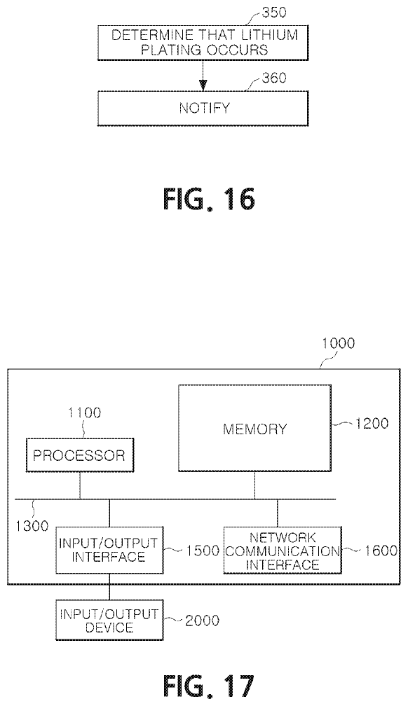

Hereinafter, a method of detecting lithium plating will be described with reference to FIGS. 15 and 16. In the present disclosure, the description of the method of detecting lithium plating and the foregoing description of the battery apparatus may be applied complementarily to each other or commonly to the extent that they are applicable in the same manner, unless there are circumstances that are mutually exclusive. Accordingly, a redundant description may be omitted. Hereinafter, the main processes of the method of detecting lithium plating will be described.

FIG. 15 is a flowchart illustrating the method of detecting lithium plating according to an embodiment of the present disclosure.

Referring to FIG. 15, for example, the method of detecting lithium plating according to an embodiment of the present disclosure may be performed by the battery apparatus 20 illustrated in FIG. 1, and the battery apparatus 20 may include the battery management system (BMS) connected to the pressure sensor unit 200 disposed on at least one outermost battery cell CE1 or CEn of the cell assembly 100 including the plurality of battery cells CE1 to CEn. For example, the method of detecting lithium plating may be performed by the battery management system (BMS).

For example, the method of detecting lithium plating according to an embodiment of the present disclosure may include a voltage detection step (S310), a resistance calculation step (S320), a pressure calculation step (S330), a pressure comparison step (S340), and a lithium plating occurrence determination step (S350).

For example, in the voltage detection step (S310), the battery apparatus 20 (see FIG. 1) may supply the driving voltage Vdri to the pressure sensor unit 200 and detect the detection voltage Vdet output from the pressure sensor unit 200.

For example, in the resistance calculation step (S320), the battery apparatus 20 (see FIG. 1) may calculate the sensor resistance Rsen of the pressure sensor unit 200 based on the detection voltage Vdet.

For example, in the pressure calculation step (S330), the battery apparatus 20 (see FIG. 1) may calculate the measured pressure Pmea based on the sensor resistance Rsen.

For example, in the pressure comparison step (S340), the battery apparatus 20 (see FIG. 1) may compare the measured pressure Pmea with the preset reference pressure Pref.

For example, in the lithium plating occurrence determination step (S350), the battery apparatus 20 (see FIG. 1) may determine the occurrence of the lithium plating when the measured pressure Pmea exceeds the reference pressure Pref.

FIG. 16 is an exemplary diagram of a notification step.

Referring to FIG. 16, for example, the method of detecting lithium plating according to an embodiment of the present disclosure may include a notification step (S360).

For example, in the notification step (S360), when it is determined that the lithium plating has occurred, the battery apparatus 20 (see FIG. 1) may provide a notification signal to notify the occurrence of the lithium plating.

FIG. 17 is a block diagram of a computing device 1000 that may fully or partially implement a battery module, a battery apparatus, and a method according to an embodiment of the present disclosure.

As illustrated in FIG. 17, for example, the computing device 1000 includes at least one processor 1100, a computer-readable storage medium 1200, and a communication bus 1300.

The processor 1100 may cause the computing device 1000 to operate according to the exemplary embodiments described above. For example, the processor 1100 may execute one or more programs stored in the computer-readable storage medium 1200. The one or more programs may include one or more computer executable instructions, which, when executed by the processor 1100, computer-executable instructions may be configured to cause the computing device 1000 to perform operations according to the exemplary embodiment.

The computer-readable storage medium 1200 is configured to store computer-executable instructions or program code, program data, and/or other suitable form of information. The program 1210 stored in the computer-readable storage medium 1200 includes a set of instructions executable by the processor 1100. In an embodiment, the computer-readable storage medium 1200 includes a memory (volatile memory such as random access memory, non-volatile memory, or a suitable combination thereof), one or more magnetic disk storage devices, optical disk storage devices, flash memory devices, other types of storage media accessed by the computing device 1000 and capable of storing desired information, or a suitable combination thereof.

The communication bus 1300 interconnects various other components of the computing device 1000, including the processor 1100 and the computer-readable storage medium 1200.

The computing device 1000 may also include one or more input/output interfaces 1500 that provide interfaces for one or more input/output devices 1400 and one or more network communication interfaces 1600. The input/output interface 1500 and the network communication interface 1600 are connected to the communication bus 1300. The network may be a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 1400 may be connected to other components of the computing device 1000 through the input/output interface 1500. Exemplary input/output devices 1400 may include input devices such as pointing devices (such as a mouse or a track pad), keyboards, touch input devices (a touch pad or a touch screen), voice or sound input devices, various types of sensor devices, and/or photographing devices, and/or output devices such as display devices, printers, speakers, and/or network cards. The exemplary input/output device 1400 may be included within the computing device 1000 as a component that constitutes the computing device 1000, or may be connected to the computing device 1000 as a separate device distinct from the computing device 1000.

Meanwhile, embodiments of the present disclosure may include a program for executing the methods described herein on a computer, and a computer-readable recording medium including the program. The computer-readable recording medium may include program instructions, local data files, local data structure, or the like, alone or a combination thereof. The medium may be designed and constituted especially for the present disclosure, or may be known to those skilled in a computer software field. Examples of the computer-readable recording medium may include a magnetic medium such as a hard disk, a floppy disk, and a magnetic tape, an optical recording medium such as a CD-ROM, a DVD, and a hardware device specially configured to store and perform program commands such as a ROM, a RAM, a flash memory, or the like. Examples of the program include a high-level language code capable of being executed by a computer using an interpreter, or the like, as well as a machine language code made by a compiler.

According to one aspect of the present disclosure, it is possible to quickly detect the pressure using the pressure sensor near the tab, which is the initial occurrence location of the lithium plating in the cell assembly, and quickly and accurately inspect the lithium plating based on the detected pressure.

Furthermore, by arranging the pressure sensor substrate so as to cover the entire body of the cell assembly, it is possible to minimize the surface pressure imbalance caused by the lithium plating, and by intensively arranging the pressure sensing line (e.g., pressure sensitive material) near the tab of the cell assembly, compared to arranging the pressure sensing line across the entire body of the cell assembly, it is possible to reduce the manufacturing costs and implement the rapid pressure detection.

Various and beneficial advantages and effects of the present disclosure are not limited to the above description, and other technical effects not specifically mentioned may be more easily understood from the following description of specific embodiments of the present disclosure.

Only specific examples of implementations of certain embodiments are described. Variations, improvements and enhancements of the disclosed embodiments and other embodiments may be made based on the disclosure of this patent document.

What is claimed is:

1. A battery module, comprising:
a cell assembly including a plurality of battery cells that include a body and at least one tab connected to the body; and
a pressure sensor unit disposed on at least one of the plurality of battery cells to detect pressure generated from the cell assembly,
wherein the pressure sensor unit includes at least one of a plurality of pressure sensors disposed in each region adjacent to a connection portion to which the tab is connected, in a body of at least one outermost battery cell among the plurality of battery cells.

2. The battery module of claim 1, wherein the pressure sensor unit includes at least one of:
a first pressure sensor and a second pressure sensor disposed in each region adjacent to the connection portion to which the at least one tab is connected, in the body of one outermost battery cell among the plurality of battery cells; and
a third pressure sensor and a fourth pressure sensor disposed in each region adjacent to the connection portion to which the tab is connected, in the body of the other outermost battery cell among the plurality of battery cells.

3. The battery module of claim 1, wherein the pressure sensor unit includes at least one of:
a first pressure sensor unit configured to be disposed between the one outermost battery cell among the plurality of battery cells and a case housing of the cell assembly; and
a second pressure sensor unit configured to be disposed between the other outermost battery cell among the plurality of battery cells and the case housing of the cell assembly.

4. The battery module of claim 3, wherein the at least one tab comprises a first tab and a second tab,
the pressure sensor unit includes:
a first substrate including a first pressure sensing line connected to a first lead and disposed in a first region adjacent to the first tab in a first direction and a second pressure sensing line connected to a second lead and disposed in a second region adjacent to the second tab in the first direction;
a second substrate stacked on the first substrate, and including a first spacer comprising an open area disposed in a region corresponding to the first region and a second spacer comprising an open area disposed in a region corresponding to the second region; and
a third substrate stacked on the second substrate, and including a third pressure sensing line connected to a third lead and disposed in a third region corresponding to the first region in a second direction intersecting the first direction and a fourth pressure sensing line connected to a fourth lead and disposed in a fourth region corresponding to the second region in the second direction.

5. The battery module of claim 4, wherein the pressure sensor unit including the first substrate, the second substrate, and the third substrate is disposed to cover the entire body of the corresponding battery cell disposed in the cell assembly.

6. The battery module of claim 4, wherein the pressure sensor unit includes:
a first pressure sensor including the first pressure sensing line, the first spacer, and the third pressure sensing line; and
a second pressure sensor including the second pressure sensing line, the second spacer, and the fourth pressure sensing line,
wherein the first pressure sensing line is disposed to face the third pressure sensing line while being physically spaced apart from the third pressure sensing line via the first spacer, and
the second pressure sensing line is disposed to face the fourth pressure sensing line while being physically spaced apart from the fourth pressure sensing line via the second spacer.

7. The battery module of claim 6, wherein a distance between the first pressure sensing line of the first pressure sensor and the third pressure sensing line varies through the first spacer depending on a level of pressure due to lithium plating occurring in a region near the first tab, and
a distance between the second pressure sensing line of the second pressure sensor and the fourth pressure sensing line varies through the second spacer depending on a level of pressure due to lithium plating occurring in a region near the second tab.

8. The battery module of claim 1, further comprising:
a protective pad disposed between the case housing of the cell assembly and the pressure sensor unit.

9. A battery apparatus, comprising:
a cell assembly including a plurality of battery cells that include a body and at least one tab connected to the body;
a pressure sensor unit disposed on at least one of the plurality of battery cells to detect pressure generated from the cell assembly; and
a control unit determining whether lithium plating occurs based on the pressure sensed by the pressure sensor unit,
wherein the pressure sensor unit includes at least one of a plurality of pressure sensors disposed in each region adjacent to a connection portion to which the tab is connected, in a body of at least one outermost battery cell among the plurality of battery cells.

10. The battery apparatus of claim 9, wherein the pressure sensor unit includes at least one of:
a first pressure sensor and a second pressure sensor disposed in each region adjacent to the connection portion to which the tab is connected, in the body of one outermost battery cell among the plurality of battery cells; and
a third pressure sensor and a fourth pressure sensor disposed in each region adjacent to the connection portion to which the tab is connected, in the body of the other outermost battery cell among the plurality of battery cells.

11. The battery apparatus of claim 10, wherein the pressure sensor unit includes at least one of:
a first pressure sensor unit configured to be disposed between the one outermost battery cell among the plurality of battery cells and a case housing of the cell assembly; and
a second pressure sensor unit configured to be disposed between the other outermost battery cell among the plurality of battery cells and the case housing of the cell assembly.

12. The battery apparatus of claim 10, wherein the pressure sensor unit includes:
a first substrate including a first pressure sensing line connected to a first lead and disposed in a first region adjacent to a first tab in a first direction and a second pressure sensing line connected to a second lead and disposed in a second region adjacent to a second tab in the first direction;
a second substrate stacked on the first substrate, and including a first spacer comprising an open area disposed in a region corresponding to the first region and a second spacer comprising an open area disposed in a region corresponding to the second region; and
a third substrate stacked on the second substrate, and including a third pressure sensing line connected to a third lead and disposed in a third region corresponding to the first region in a second direction intersecting the first direction and a fourth pressure sensing line connected to a fourth lead and disposed in a fourth region corresponding to the second region in the second direction.

13. The battery apparatus of claim 12, wherein the pressure sensor unit including the first substrate, the second substrate, and the third substrate is disposed to cover the entire body of the corresponding battery cell disposed in the cell assembly.

14. The battery apparatus of claim 12, wherein the pressure sensor unit includes:
a first pressure sensor including the first pressure sensing line, the first spacer, and the third pressure sensing line; and
a second pressure sensor including the second pressure sensing line, the second spacer, and the fourth pressure sensing line,
the first pressure sensing line is disposed to face the third pressure sensing line while being physically spaced apart from the third pressure sensing line via the first spacer, and
the second pressure sensing line is disposed to face the fourth pressure sensing line while being physically spaced apart from the fourth pressure sensing line via the second spacer.

15. The battery apparatus of claim 14, wherein a distance between the first pressure sensing line and the third pressure sensing line varies through the first spacer depending on a level of pressure due to lithium plating occurring in a region near the first tab, and
a distance between the second pressure sensing line and the fourth pressure sensing line varies through the second spacer depending on a level of pressure due to lithium plating occurring in a region near the second tab.

16. The battery apparatus of claim 9, further comprising:
a protective pad disposed between the case housing of the cell assembly and the pressure sensor unit.

17. The battery apparatus of claim 9, wherein the control unit is included in a battery management system connected to the cell assembly.

18. The battery apparatus of claim 9, wherein the control unit includes:
a voltage detection unit supplying a driving voltage to the pressure sensor unit and detecting a detection voltage output from the pressure sensor unit; and
a lithium plating determination unit determining the occurrence of the lithium plating based on the detection voltage and outputting a notification signal when the lithium plating occurs.

19. A method for inspecting lithium plating performed in a battery management system connected to a pressure sensor unit disposed on at least one outermost battery cell of a cell assembly including a plurality of battery cells, the method comprising:
supplying a driving voltage to the pressure sensor unit and detecting a detection voltage output from the pressure sensor unit; and
calculating a sensor resistance of the pressure sensor unit based on the detection voltage;
calculating a measured pressure based on the sensor resistance;
comparing the measured pressure with a preset reference pressure; and
determining the occurrence of the lithium plating when the measured pressure exceeds the reference pressure.

20. The method of claim 19, further comprising:
providing a notification signal when it is determined that the lithium plating has occurred.
